(19) United States
(12) Patent Application Publication
(10) Pub. No.: US 2012/0239554 A1
(43) Pub. Date: Sep. 20, 2012

(54) System And Method To Eliminate Receiving Coins As Cents Due Less Than One Dollar

(76) Inventors: Christopher Primbas, Schaumburg, IL (US); Philip Thomas Stamataky, Chicago, IL (US)

(21) Appl. No.: 13/046,837

(22) Filed: Mar. 14, 2011

(51) Int. Cl. G06Q 40/00

(52) U.S. Cl. 705/39

(57) ABSTRACT

A system and method are provided for facilitating a transaction between a customer and a merchant in which a cash change amount between 1¢ and 99¢ is due the customer. According to an aspect of the disclosure, a method includes the steps of receiving information regarding an account associated with a customer, a merchant and a tracking fee amount; charging a tracking fee to an account associated with a customer; and crediting the tracking fee to an account associated with a merchant. Subsequently, an amount given by the sum of the amount of credit purchased and the tracking fee is credited to an account associated with a customer and charged to an account associated with a merchant. Accounts associated with a customer and a merchant are typically maintained electronically, and the charging and crediting are performed by a computing device. The credit purchase amount and tracking fee are equal.

### FIELD OF THE DISCLOSURE

This disclosure relates to systems for facilitating retail transactions, and more particularly to a system and method for facilitating cash transactions without the need for a customer to receive coins as change due from a cash purchase and transaction.

### BACKGROUND OF THE DISCLOSURE

When a customer purchases a product using currency of greater value than the total cost of that product, a customer is owed back an amount of currency, typically in both paper and coins. Coin currency, before it becomes coin change due, is a necessity for retailers to conduct cash business. A small cash purchase whose total cost does not also include a fraction of a dollar, or does not create coin change due less than $1, is a rare occurrence. The total cost of almost all retail product purchases includes a fraction of a dollar, often due to sales tax.

While customers typically put their paper change back into circulation, this is often not the case for coin change. Because of the way customers manage their coin change vs. paper change, a retailer's need for coin currency is dependent on providers of coin currency, such as their bank or federal depository, as opposed to relying on customers purchasing with coins and re-circulating coins back to retailers. As a result of coin currency's manageability issues, and unlike paper currency, a significant portion of coin change received by a customer from a cash purchase ends up discarded, unsecured, unused, forgotten, lost, misplaced or stored out of economic circulation. Coin Currency staying in a register rather than being disbursed means there is no need to withdraw more coin currency from a bank to re-fill a register, therefore keeping more currency in the economy.

A customers' perceived value of an amount of coin change received may be evidenced by small trays located by small-ticket retail store registers containing coin change, or more specifically, discarded pennies, with an occasional nickel or dime that was discarded by previous cash based customers. This supports the suggestion that physically receiving and managing an amount of coins received as change due from a cash transaction may have less value to a customer than simply discarding an amount of coin change received. Inconvenience to a customer may be viewed as having an inherent and perceived cost to a customer; it may be presumed that a customer discarding an amount of coin change into a tray by a cash register values some form of convenience more than receiving and physically managing an amount of coin change.

There is a need for an efficient and convenient system for keeping more currency in the economy and keeping more coin change out of lost, misplaced, forgotten and/or non-circulated storage.

### SUMMARY OF THE DISCLOSURE

In accordance with the disclosure, a system and method are provided for facilitating a cash transaction between a customer and a merchant where an amount of coin change between 1¢ and 99¢ is due to the customer.

According to an aspect of the disclosure, a method includes the steps of receiving information regarding an account associated with a customer, a merchant and a purchase of credit using any coin change due less than $1, by charging what is hereby referred to as “a tracking fee” to a card associated with an account that is associated with a customer, that is equal to the amount of credit purchased and crediting the tracking fee to an account associated with a merchant. Subsequently, an amount equal to the cash purchase of credit and an amount equal to the electronic purchase of a tracking fee is credited to an account associated with a customer and charged to an account associated with a merchant to complete a system and method to purchase credit using any coin change due to a customer from a cash transaction.

These accounts associated with a merchant and a customer are typically maintained electronically, and the charging and crediting are performed by a computing device. The credit purchase amount and tracking fee are equal. In an embodiment, the information regarding an account associated with a customer is encoded on a card and read by a card reader connected to a network at the merchant's location. The card advantageously may function also as a credit card, used to make purchases at a wide variety of merchant locations, including locations that may not participate in the method described above.

According to another aspect of the disclosure, a system for facilitating a transaction between a customer and a merchant in which coin change between 1¢ and 99¢ is due to a customer, includes at least one electronically readable device such as a card associated with an account, an electronic card reader connected to a network and an electronic database connected to a network. The database stores the information relating to an account associated with a customer. The database is configured to receive information regarding an account associated with a customer, and more specifically, a purchase of a tracking fee equal to a cash purchase of credit, charged to an account associated with a customer and credited to an account associated with a merchant; and subsequently causing an amount given by the sum of the cash purchase of credit and by the sum of the electronic purchase of a tracking fee to be credited to an account associated with a customer and charged to an account associated with a merchant to complete a cash purchase of credit.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art can appreciate the disclosed conception and specific embodiment as a basis for designing or modifying structures that carry out the same purposes of the present disclosure, and that such other structures do not depart from the spirit and scope of the disclosure in its broadest form.

### BRIEF DESCRIPTION OF THE DRAWINGS

FIGS. 1A and 1B schematically illustrate a conventional retail transaction where a transfer of metal coins from the merchant to the customer (coin change) is required.

FIGS. 2A and 2B schematically illustrate a retail transaction in which a customer uses a card associated with an account, in accordance with an embodiment of the disclosure, to purchase a tracking fee equal to the amount of credit purchased with any coin change due less than $1.

FIG. 3 is a flow diagram illustrating a method in which a retail purchase involving a card associated with an account is transacted in accordance with an embodiment of the disclosure.

FIG. 4 schematically illustrates a system for facilitating retail transactions in accordance with an embodiment of the disclosure.

### DETAILED DESCRIPTION

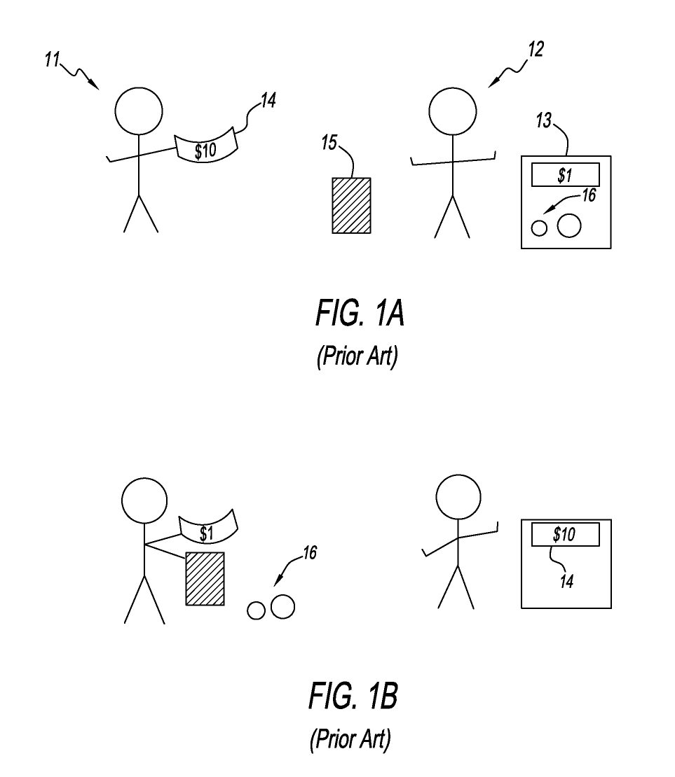

In a conventional retail transaction (see FIG. 1A), customer 11 visits merchant 12 to purchase item 15. Merchant 12 has a cash register 13 in which he keeps paper and coin currency 16. Customer 11 tenders paper currency 14 whose value is greater than the total sales price. In this particular example, item 15 may have a price of $8.65 and currency 14 comprises one $10 note; the change due to the customer includes 35¢. (The customer may also receive change totaling $1 in paper form, in this example a $1 note; this is not related to the system and method disclosed herein.) At the conclusion of the transaction (FIG. 1B), the merchant has placed the paper currency 14 in the cash register, and owes 35¢ to the customer. (In this example, the 35¢ change comprises at least two metal coins.) The metal coins 16 are now considered change due and susceptible to being misplaced, discarded, or otherwise removed from economic circulation by a customer.

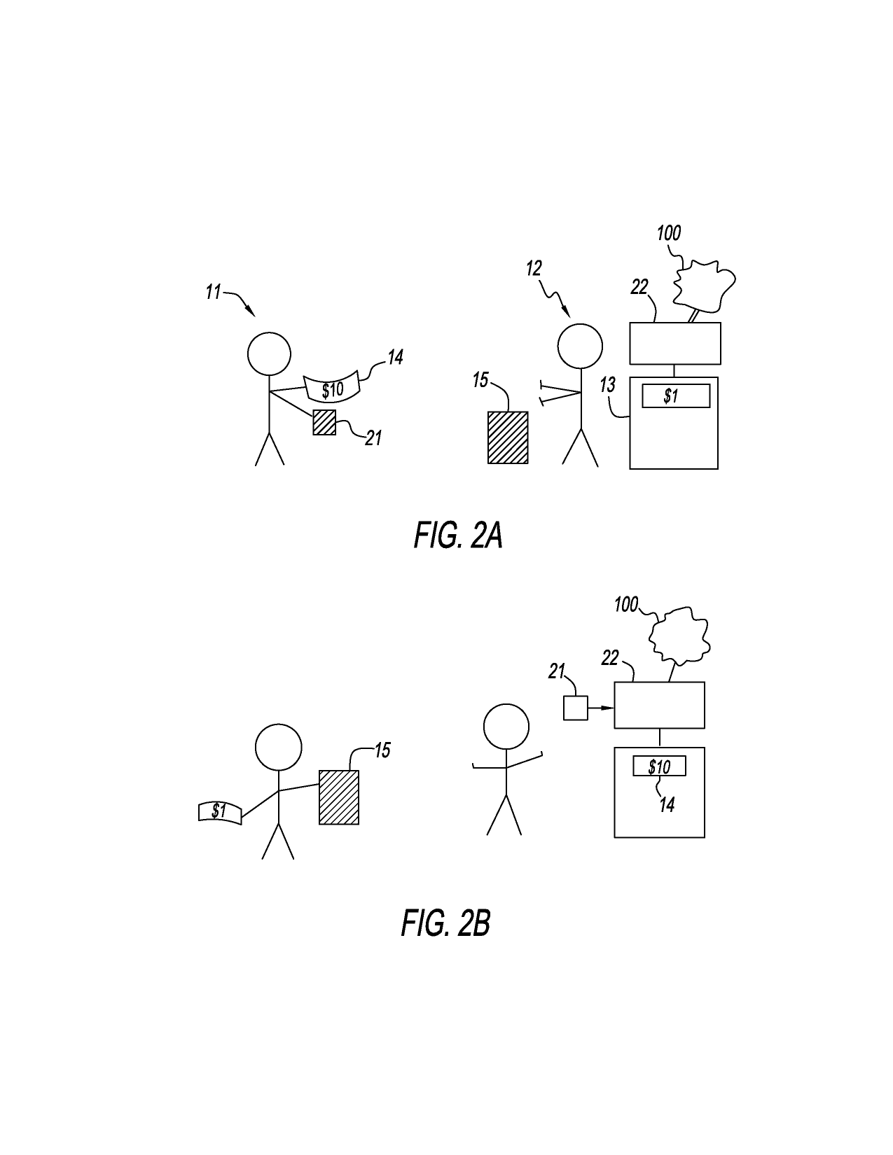

A retail transaction in accordance with the disclosure is illustrated in FIGS. 2A and 2B. FIG. 2A shows customer 11 purchasing item 15, priced at $8.65, from merchant 12 and tendering a $10 paper note, as in FIG. 1A. The customer receives a $1 paper note as change, as in the conventional transaction. However, instead of receiving 35¢ in coin change, the customer elects to purchase a 35¢ credit from the merchant. According to an embodiment of the disclosure, this purchase of credit is initiated, certified and recorded by the system and method by a customer 11 purchasing a transfer fee by handing the merchant a card associated with an account 21. The merchant has a card reader device 22 (advantageously connected to cash register 13) which is connected via network 100 to a network (not shown in FIG. 2A). The merchant uses card reader 22 to obtain information from card 21, transmit information regarding the tracking fee purchase via network 100, and initiate a tracking process (described in more detail below); see FIG. 2B. The customer thus receives cents due in the form of credit rather than coins, which may accumulate and be spent like any other accumulated credit by using a card associated with an account. Card 21 is advantageously linked to a credit card network so that the accumulated credit may be spent at a wide variety of retailers. It should be noted that although the credit may be purchased only at retailers participating in the system, the credit may be spent at both participating and non-participating retailers who accept credit cards linked to a credit card network.

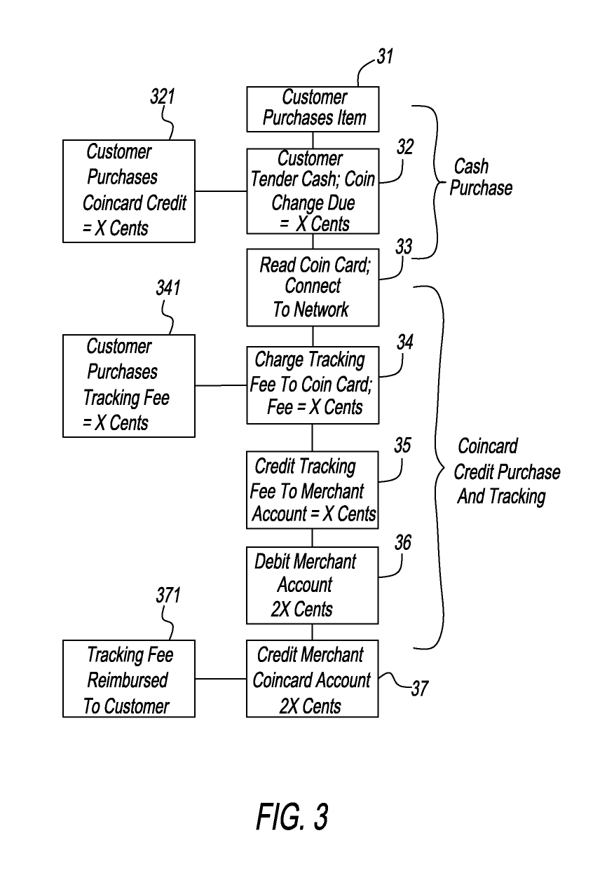

A process for concluding a purchase of credit, and tracking that purchase, is shown in the flow diagram of FIG. 3. The customer first makes a cash purchase of an item, as in a typical retail transaction (step 31). The customer tenders cash (step 32), so that there is coin change due the customer in some amount (x cents, between 1¢ and 99¢). At this point (321), the customer elects to purchase a credit in the amount of x cents. The merchant causes the card associated with an account to be read (step 33); the card reader is connected to a network, and information regarding the purchase of a tracking fee is transmitted to a database connected to a network.

In this embodiment, tracking the cash purchase of credit is performed by charging a tracking fee equal to the amount of credit purchased. This tracking charge/debit (in the amount of x cents) acts as a marker to track the amount of credit purchased with any coin change due less than $1.

In step 34, the tracking fee (x cents) is charged to the account associated with the customer. When using an existing credit card network to track purchases of credit using any coin change due less than $1, the merchant charges, or debits a card associated with an account an amount equal to the amount of credit purchased with any coin change due less than $1 (x cents). At this point (341), the customer has made an electronic purchase of a tracking fee equal to and in addition to a cash purchase of credit in the amount of x cents.

The tracking-fee purchase is credited to the merchant's account (step 35), thereby ensuring a record of the amount of credit purchased that is accessible by the merchant. Then (step 36) the account associated with a merchant is debited the amount of the tracking fee purchased and the amount of credit purchased; thus, the merchant's accounting is in the same state as if the merchant had dispensed coins as cents due from his cash register rather than dispensing cents due from his/her account. In step 37, the account associated with a customer is credited the tracking fee and the credit purchased. At this point (371), an account associated with a customer is credited the tracking fee and the cash purchase of credit to complete a credit purchase transaction.

In an embodiment, the system uses a card associated with an account and read by a standard card reader that is connected to a network to track the amount of credit sold by the merchant and purchased by the consumer using any coin change due totaling an amount less than $1. The system uses data generated by using the card read by a card reader and connected to a network to track and to verify the amount of credit purchased using any coin change due less than $1. The system and method embodying the disclosure may use any network that can be used to track any credit purchased with any coin change due less than $1.

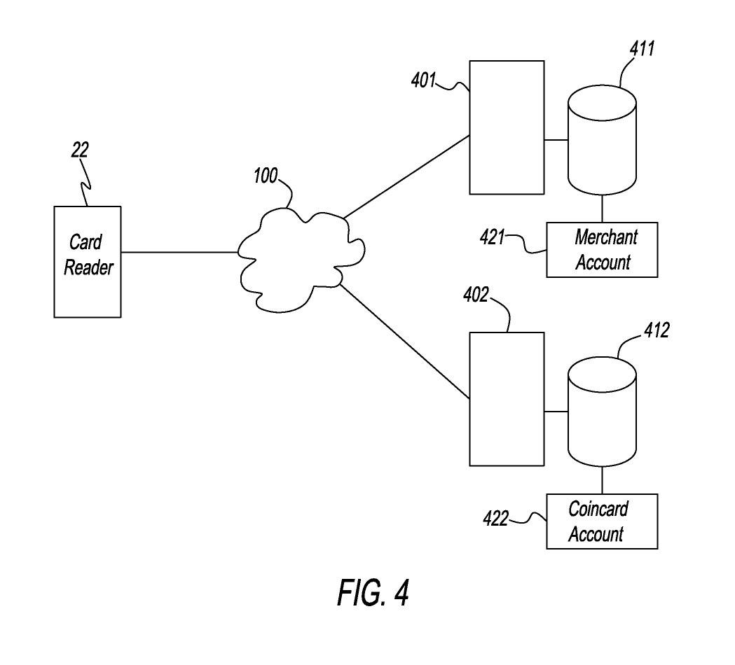

A system embodying the disclosure is shown schematically in FIG. 4. Card reader 22 at the merchant's location is connected via network 100 to a computing system having a processor and a storage device, shown as server 401 and memory 411. Memory 411 includes information 421 relating to the merchant. As described above, an account associated with a merchant 421 is credited by x cents when the tracking fee is purchased, and debited by 2x cents at the conclusion of the process. An account associated with a customer 422 may be resident on another memory device 412 (part of a computing system including server 402, and linked to other devices via network 100).

It will be appreciated that a system and method embodying the disclosure, as described above, has the following features:

(1) Credit is sold at a merchant's cash register/point of sale location, and only in connection with a cash purchase where coin change less than $1 is due to a customer.

(2) A customer can buy up to 99¢ in credit per purchase of credit.

(3) The merchant only accepts cash as payment for credit.

(4) In order to purchase credit, the consumer must also purchase a tracking fee.

(5) The merchant only accepts a card associated with an account as the instrument of payment for the tracking fee.

(6) The tracking fee is equal to the amount of credit purchased.

(7) The tracking fee is used by the system to identify, authorize, validate, certify, authenticate, and account for a cash-based credit purchase transaction, that also represents a service agreement between customer and merchant, namely that the merchant agrees to credit the tracking fee and an amount equal to the cash purchase of credit to an account associated with a customer.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings such as, for example, where a consumer can wave and pay for an item with a readable device which may contain an embedded Near Field Communication (NFC) microchip that communicates with a reader or other relevant electronically readable devices to process payment transactions. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. A method for facilitating a cash transaction between a customer and a merchant in which an amount between 1¢ and 99¢ in coin change is due to the customer, the method comprising:
receiving information regarding an account associated with a customer, the merchant and an electronic tracking fee purchase by;
charging a tracking fee to an account associated with a customer;
crediting the tracking fee to an account associated with a merchant;
and subsequently crediting to an account associated with a customer an amount given by the sum of credit purchased and tracking fee purchased, and charging said amounts to an account associated with a merchant,
wherein
all said accounts are maintained electronically, and
said charging and said crediting are performed by a computing device.

2. A method according to claim 1, wherein said credit purchase amount and said tracking fee are equal.

3. A method according to claim 1, wherein said information regarding an account associated with a customer is encoded on a card associated with an account, and said receiving step includes reading the card using a card reading device.

4. A method according to claim 3, wherein a card reading device is connected to a computing device via a network.

5. A method according to claim 3, wherein the card associated with an account is associated with the customer.

6. A method according to claim 1, wherein in said transaction the customer tenders cash to the merchant.

7. A system for facilitating a transaction between a customer and a merchant in which a cash amount between 1¢ and 99¢ is due a customer, the system comprising:
at least one storage device storing information relating to an account associated with a customer and an account associated with a merchant; and
a computing device configured to
receive information regarding an account associated with a customer, a merchant and said tracking fee amount;
cause a tracking fee to be charged to an account associated with a customer;
cause the tracking fee to be credited to an account associated with a merchant; and
subsequently cause an amount given by the sum of credit purchased with coin change due and said tracking fee purchased electronically to be credited to an account associated with a customer and charged an account associated with a merchant.

8. A system according to claim 7, wherein said credit purchase amount and said tracking fee are equal.

9. A system according to claim 7, further comprising an electronic device for reading information regarding an account associated with a customer encoded on an electronically readable device such as a card.

10. A system according to claim 9, wherein the electronic device is connected to a network.

11. A system according to claim 9, wherein the electronically readable device is a card associated with said account associated with a customer.
